(19) United States
(12) Patent Application Publication
(10) Pub. No.: US 2017/0277390 A1
(43) Pub. Date: Sep. 28, 2017

(54) PROVIDING USER-DEFINED APPLICATION START PAGES

(71) Applicant: International Business Machines Corporation, Armonk, NY (US)

(72) Inventors: Xu Chang, Beijing (CN); Fu Bao Fan, Beijing (CN); Jun Hui Ma, Beijing (CN); Jiandong Yin, Beijing (CN)

(21) Appl. No.: 15/078,306

(22) Filed: Mar. 23, 2016

(51) Int. Cl. G06F 3/0481; G06F 17/30; G06F 11/30

(52) U.S. Cl. CPC G06F 3/04817; G06F 11/3003; G06F 17/3089

(57) ABSTRACT

An ability to present user-defined start pages on graphical user interfaces is provided. At least one of a user interface of a computing device, an operating system executing on the computing device, and an application executing on the computing device is monitored to detect, on the user interface, one or more trigger conditions that are associated with the application. The one or more trigger conditions are detected, and in response, a start-page database is queried for information that describes, at least in part, a user-defined start page that is associated with the application. The user-defined start page, and not a default start page, is presented on a screen of the computing device via an interface with at least one of the application and the operating system.

### TECHNICAL FIELD

The present invention relates generally to the field of graphical user interfaces and, more particularly, to providing user-defined application start pages.

### BACKGROUND

Graphical user interfaces (GUIs) are a type of computer interface that facilities human-computer interaction via various graphical elements (i.e., widgets), as opposed to text-based interfaces (e.g., a command-line interface). Desktop computers, laptop computers, portable media players, smartphones, and various other computing devices can provide GUIs. In general, a computing device that provides a GUI enables a user to interact with the computing device through direct manipulation of widgets, such as icons, buttons, and menus. Applications, for example, can be represented as respective icons (i.e., pictorial representations of an object). When a user clicks on, hovers over, or otherwise selects and activates an icon, the GUI instructs an operating system to execute code that is associated with the application.

### SUMMARY

According to one embodiment of the present invention, a method for presenting start-pages on a graphical user interface is provided. The method includes: monitoring, by one or more computer processors, at least one of a first user interface of a computing device, an operating system executing on the computing device, and an application executing on the computing device to detect one or more trigger conditions that are associated with the application on the first user interface; detecting, by one or more computer processors, the one or more trigger conditions on the first user interface, and in response, querying, by one or more computer processors, a start-page database for information that describes, at least in part, a user-defined start page that is associated with the application; and interfacing, by one or more computer processors, with at least one of the application and the operating system such that the first user interface presents the user-defined start page and not a default start page on a screen of the computing device.

According to another embodiment of the present invention, a computer program product for presenting start-pages on a graphical user interface is provided. The computer program product comprises a computer readable storage medium and program instructions stored on the computer readable storage medium. The program instructions include: program instructions to monitor at least one of a first user interface of a computing device, an operating system executing on the computing device, and an application executing on the computing device to detect one or more trigger conditions that are associated with the application on the first user interface; program instructions to detect the one or more trigger conditions on the first user interface, and in response, querying, by one or more computer processors, a start-page database for information that describes, at least in part, a user-defined start page that is associated with the application; and program instructions to interface with at least one of the application and the operating system such that the first user interface presents the user-defined start page and not a default start page on a screen of the computing device.

According to another embodiment of the present invention, a computer system for presenting start-pages on a graphical user interface is provided. The computer system includes one or more computer processors, one or more computer readable storage media, and program instructions stored on the computer readable storage media for execution by at least one of the one or more processors. The program instructions include: program instructions to monitor at least one of a first user interface of a computing device, an operating system executing on the computing device, and an application executing on the computing device to detect one or more trigger conditions that are associated with the application on the first user interface; program instructions to detect the one or more trigger conditions on the first user interface, and in response, querying, by one or more computer processors, a start-page database for information that describes, at least in part, a user-defined start page that is associated with the application; and program instructions to interface with at least one of the application and the operating system such that the first user interface presents the user-defined start page and not a default start page on a screen of the computing device.

### BRIEF DESCRIPTION OF THE DRAWINGS

FIG. 1 is a functional block diagram illustrating a computing environment, in accordance with an embodiment of the present invention.

FIGS. 2A and 2B are schematic diagrams of a GUI on a client device within the computing environment depicted in FIG. 1, in accordance with an embodiment of the present invention.

FIG. 3 is a schematic diagram of features of the start-page routing logic described herein, in accordance with an embodiment of the present invention.

FIG. 4 is a flowchart depicting operations for presenting a user-defined start page on a computing device within the computing environment of FIG. 1, in accordance with an embodiment of the present invention.

FIG. 5 is a block diagram of components of a computing device executing operations for presenting start pages on a graphical user interface, in accordance with an embodiment of the present invention.

### DETAILED DESCRIPTION

Embodiments of the present invention recognize that a goal of GUIs is to improve the efficiency and ease of interaction with a computing device. Embodiments of the present invention also recognize that applications often require a user to navigate through various menus, toolbars, and/or windows to utilize various features of applications. Embodiments of the present invention further recognize that, in general, some users will utilize only one or a small number of specific features of an application. One technique for improving the efficiency and ease of interaction with computing devices is to minimize the number of user inputs that are needed to utilize various features of applications. If, for example, a user generally navigates through several menus each time the user starts an application in order to access a specific feature, it is advantageous to reduce the number of menus that the user must navigate through to access the specific feature. As user herein, a “start page” is content (e.g., a graphical representation of a file, a menu, a toolbar, or a combination of the aforementioned graphical elements) that an application presents on a GUI in response to user interactions on the GUI that start, wake, or otherwise cause the application to execute. Accordingly, embodiments of the present invention provide, among other things, an ability for a user of a computing device to associate user-defined start pages with respective application(s).

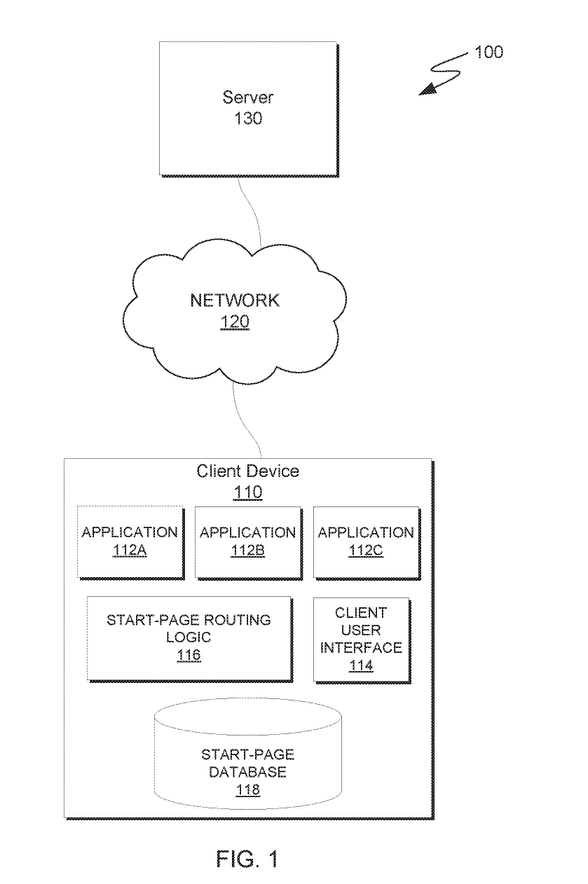

Embodiments of the present invention will now be described in detail with reference to the Figures. FIG. 1 is a functional block diagram illustrating a computing environment, in accordance with an embodiment of the present invention. For example, FIG. 1 is a functional block diagram illustrating computing environment 100. Computing environment 100 includes client device 110 and server 130 communicatively connected over network 120. Client device 110 includes applications 112 (i.e., application 112A, application 112B, and application 112C, which are collectively referred to as applications 112 herein), client user interface 114, start-page routing logic 116, and start-page database 118.

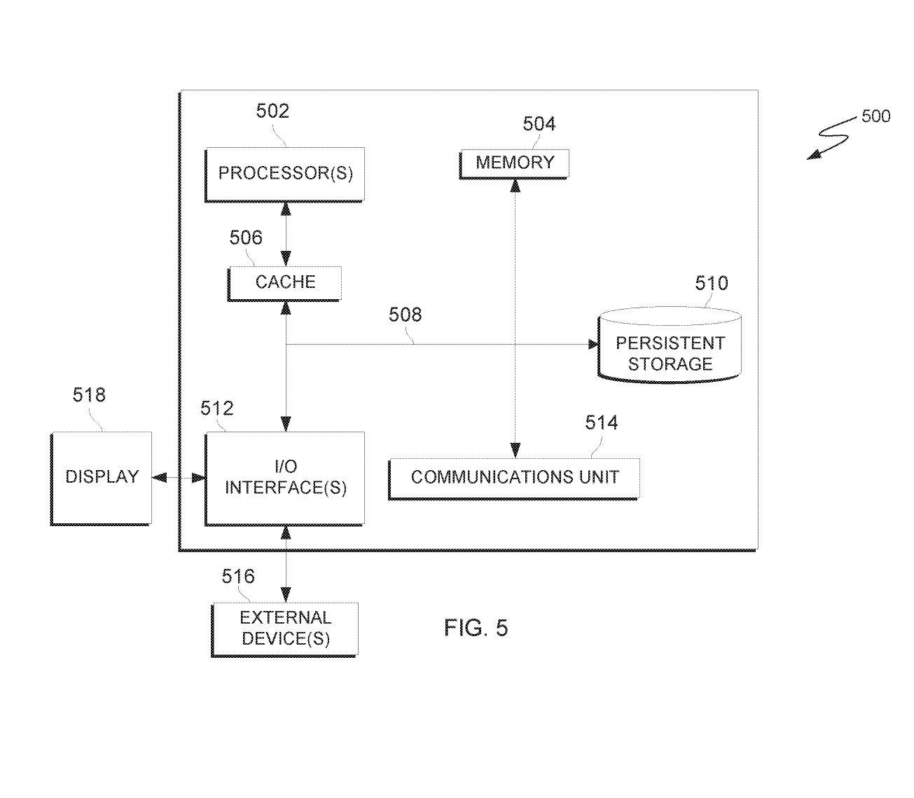

In various embodiments, client device 110 is a computing device that can be a standalone device, a server, a laptop computer, a tablet computer, a netbook computer, a personal computer (PC), or a desktop computer. In another embodiment, client device 110 represents a computing system utilizing clustered computers and components to act as a single pool of seamless resources. In general, client device 110 can be any computing device or a combination of devices with access to server 130, and with access to and/or capable of executing applications 112, client user interface 114, and start-page routing logic 116. Client device 110 can include internal and external hardware components, as depicted and described in further detail with respect to FIG. 5.

In the embodiment depicted in FIG. 1, applications 112 are stored on client device 110. In other embodiments, one or more of application 112A, application 112B, and application 112C can reside on another computing device, provided that each can access and is accessible by client user interface 114 and start-page routing logic 116. In yet other embodiments, or more of application 112A, application 112B, and application 112C can be stored externally (e.g., on server 130) and accessed through a communication network, such as network 120. Similarly, one or more of applications 112 can, in various embodiments, access data stored in one or more data repositories on server 130 (not shown) via a communication network, such as network 120. In addition, applications 112 can include a greater or lesser number of applications without departing from the scope of the present disclosure.

Network 120 can be, for example, a local area network (LAN), a wide area network (WAN) such as the Internet, or a combination of the two, and may include wired, wireless, fiber optic or any other connection known in the art. In general, network 120 can be any combination of connections and protocols that will support communications between client device 110 and server 130, in accordance with a desired embodiment of the present invention.

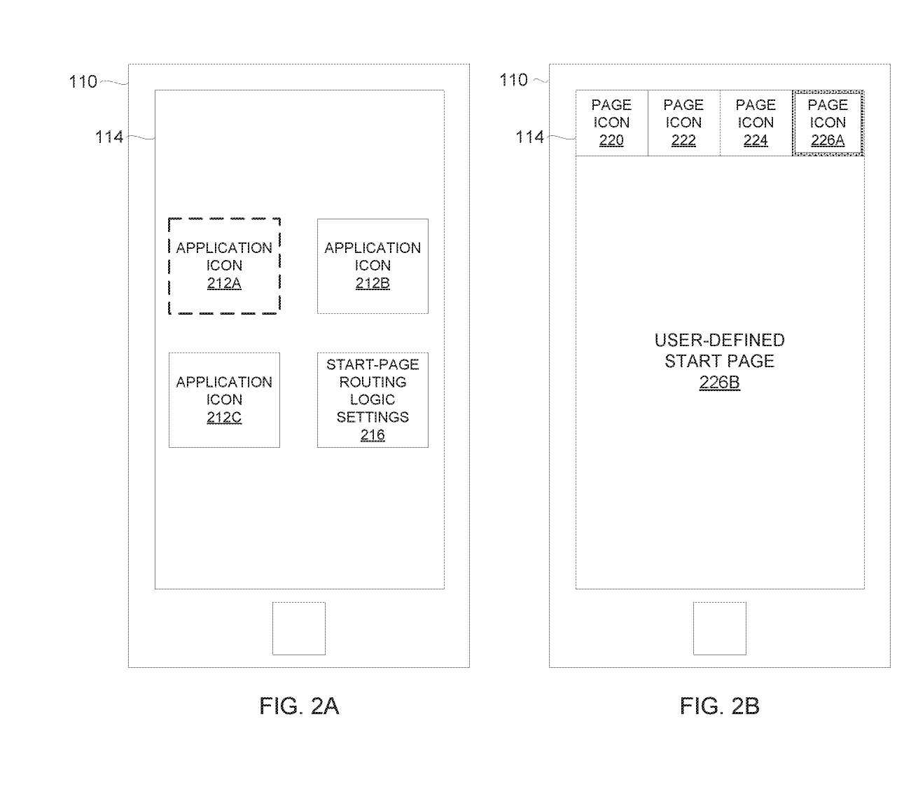

Client device 110 includes a GUI, client user interface 114, which executes locally on client device 110 and operates to provide a GUI to a user of client device 110. Client user interface 114 further operates to receive user input from the user via the provided user interface, thereby enabling the user to interact with client device 110 (e.g., via a touch screen, a microphone and speech recognition software, a keyboard, a mouse, or any combination of user-input devices). In one embodiment, client user interface 114 provides a user interface that enables a user of client device 110 to interact with applications 112 and start-page routing logic 116, as described herein. One example of client user interface 114 is discussed with respect to FIGS. 2A and 2B. In various examples, the user interacts with (i) applications 112 to access respective features of applications 112 and (ii) start-page routing logic 116 to respectively associate user-defined start pages with one or more of application 112A, application 112B, and application 112C. In some embodiments, client user interface 114 is stored on client device 110. In other embodiments, client user interface 114 is stored on another computing device (e.g., server 130), provided that client user interface 114 can access and is accessible by applications 112 and start-page routing logic 116.

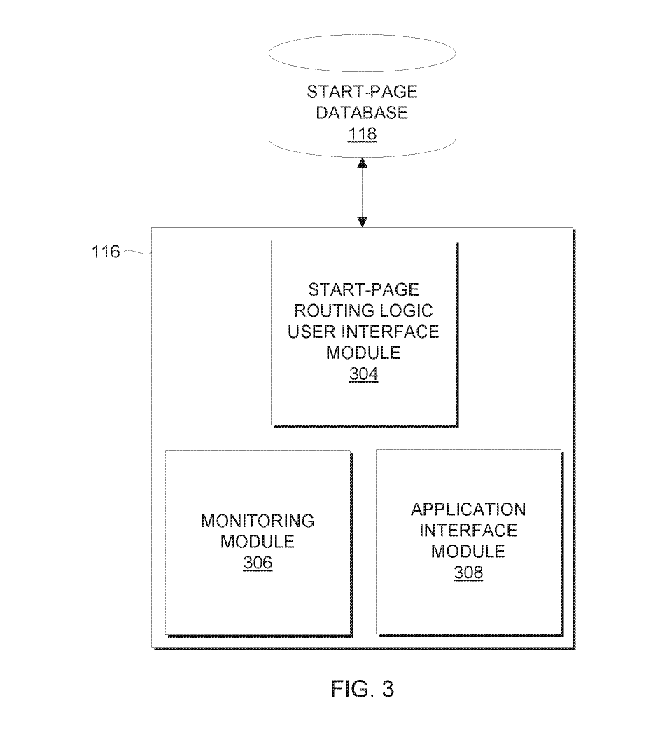

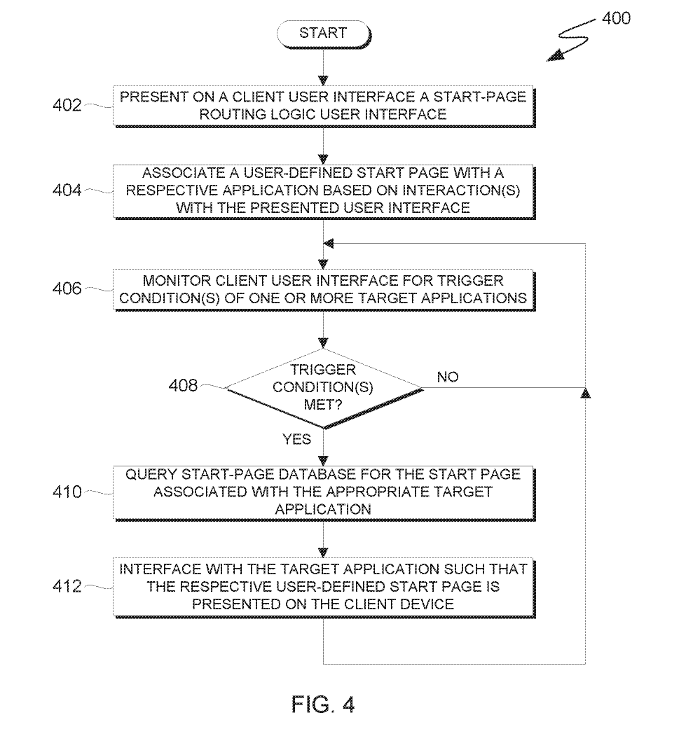

In the embodiment depicted in FIG. 1, start-page routing logic 116 is stored on client device 110. In other embodiments, start-page routing logic 116 can reside on another computing device (e.g., server 130), provided that start-page routing logic 116 can access and is accessible by applications 112, client user interface 114, and start-page database 118. In yet other embodiments, start-page routing logic 116 can be stored externally (e.g., on server 130) and accessed through a communication network, such as network 120. In general, start-page routing logic 116 operates to provide a GUI that enables a user of client device 110 and applications 112 to respectively associate user-defined start pages with one or more of application 112A, application 112B, and application 112C. In general, start-page routing logic 116 also operates to cause client user interface 114 to present, on a screen of client device 110, an appropriate start-page when one of applications 112 is executed via client user interface 114, as discussed with respect to FIGS. 3 and 4.

Start-page database 118 is a data repository that may be written to and read by start-page routing logic 116. One or both of data and logic for presenting a user-defined start page when application 112A, application 112B, or application 112C is executed (i.e., following start-up of an application or upon waking an application) can be stored to start-page database 118. In some embodiments, start-page database 118 may be written to and read by programs and entities outside of computing environment 100 in order to populate the repository with one or both of data and logic that is associated with various user-defined start-page(s). Additionally, start-page database 118 can reside on server 130 in various embodiments, and start-page routing logic 116 can access start-page database 118 on server 130 via network 120.

In various embodiments, server 130 is a computing device that can be a standalone device, a server, a laptop computer, a tablet computer, a netbook computer, a personal computer (PC), a desktop computer, a personal digital assistant (PDA), a smart phone, or any programmable electronic device capable of communicating with client device 110 via network 120. In another embodiment, server 130 represents a computing system utilizing clustered computers and components to act as a single pool of seamless resources. In some embodiments, server 130 can be any computing device or a combination of devices with access to client device 110, and with access to and/or capable of executing some or all of application 112A, application 112B, application 112C, and start-page routing logic 116 and/or capable of storing data utilizes by some or all of application 112A, application 112B, application 112C, and start-page routing logic 116. In the embodiment depicted in FIG. 1, a single server (i.e., server 130) is communicatively connect to client device 110 via network 120 for illustrative simplicity. In other embodiments, network 120 communicatively connects, to client device 110, a plurality of analogous servers that variously execute code, store data, or execute and store data for application 112A, application 112B, application 112C, and start-page routing logic 116. In yet other embodiment, server 130 is omitted and client device 110 executes code and stores data for applications 112 and start-page routing logic 116.

FIGS. 2A and 2B are schematic diagrams of a GUI on a client device within the computing environment depicted in FIG. 1, in accordance with an embodiment of the present invention. In the embodiment depicted in FIGS. 2A and 2B client device 110 is a smartphone.

More specifically, the embodiment of client user interface 114 depicted in FIG. 2A includes application icon 212A, application icon 212B, and application icon 212C, which are respectively associated with application 112A, application 112B, and application 112C of FIG. 1. When a user of client device 110 selects and activates one of application icon 212A, application icon 212B, and application icon 212C, client user interface 114 causes client device 110 to execute code that corresponds to the selected application to start-up or wake the selected application such that client user interface 114 presents a start page on a screen of client device 110. The start page can be a default start page of the selected application or a user-defined start page if start-page routing logic 116 is configured for the selected application as described herein. In FIG. 2A, the hash pattern surrounding application icon 212A indicates that a user has selected and activated application icon 212A via client user interface 114. In FIG. 2B, client user interface 114 presents user-defined start page 226B and various features of application 112A, as described herein.

In the depicted embodiment, client user interface 114 also includes an icon for start-page routing logic settings 216. When a user of client device 110 selects and activates the icon for start-page routing logic settings 216, start-page routing logic 116 causes client user interface 114 to present a user interface for, at least in part, respectively associating user-defined start pages with applications 112.

In the embodiment depicted in FIG. 2B, client user interface 114 present a plurality of page icons (i.e., page icon 220, page icon 222, page icon 224, and page icon 226A) and user-defined start page 226B on a screen of client device 110. In this embodiment, page icon 220, page icon 222, and page icon 224 are associated with various pages that include respective menus in a hierarchical page system. For example, page icon 220 is associated with a default start page of application 112A. Selecting an option from a menu on the default start page navigates to a page that is associated with page icon 222. Similarly, selecting an option from a menu on the page that is associated with page icon 222 navigates to a page that is associated with page icon 224, and selecting an option from a menu on the page that is associated with page icon 224 navigates to a page that is associated with page icon 226A. The hash pattern around page icon 226A indicates that the page associated with page icon 226A is the active page of application 112A. User-defined start page 226B is the page that is associated with page icon 226A. Stated differently, application 112A can be modeled as a system of nodes in which the page associated with page icon 220 is associated as a parent node and the pages that are associated with page icons 222, 224, and 226A are associated with a sequence of descendant nodes in which nodes associated with page icons 222 and 224 lie between the nodes associated with page icon 220 and 226A (e.g., page icon 226A is associated with a leaf node). In general, a user of client device 110 must interact with client user interface 114 to traverse nodes in this example. Accordingly, at least three user interactions with client user interface 114 are required to start application 112A and navigate to user-defined start page 226B when the start page is the default start page (i.e., the start page associated with page icon 220). As applied to this example, however, embodiments of the present inventions advantageously provide a user of client device 110 with the capability of setting user-defined start page 226B as the start-page for application 112A. Instead of presenting the default start page upon the selection and activation of application icon 212A, client user interface 114 presents user-defined start page 226B on the screen of client device 110 when user-defined start page 226B is set as the start page for application 112A via start-page routing logic settings 216. Therefore, this embodiment of the present invention can advantageously reduce the number of interactions with client user interface 114 that are necessary to navigate to user-defined start page 226B from three to one. As a result, the user of client device 110 can select and activate application icon 212A to cause client user interface 114 to present user-defined start page 226B on the screen of client device 110.

FIG. 3 is a schematic diagram of features of the start-page routing logic described herein, in accordance with an embodiment of the present invention. More specifically, FIG. 3 depicts an embodiment of start-page routing logic 116 that includes start-page routing user interface module 304, monitoring module 306, and application interface module 308. In general, start-page routing logic 116 can be implemented as an application that is executed by an operating system of client device 110; as one or more daemon processes of an operating system of client device 110; as one or more plug-ins that respectively modify one or more of application 112A, application 112B, and application 112C; or as any combination of the aforementioned types of code.

In the embodiment depicted in FIG. 3, start-page routing logic user interface module 304 operates to provide a GUI for respectively associating user-defined start pages with applications that start-page routing logic 116, or a respective instance of start-page routing logic 116, can interface with, as described herein. Such applications are also referred to as “target applications” herein. In various embodiments, an application becomes a “target application” in response associating the application with a respective user-defined start page via start-page routing logic user interface module 304. In the embodiment depicted in FIGS. 2A and 2B, for example, a user of client device 110 can select and activate the icon for start-page routing logic settings 216 on client user interface 114 to cause start-page routing logic 116 to execute logic corresponding to start-page routing logic user interface module 304. A user of client device 110 can utilize the user interface that is provided by start-page routing logic user interface module 304 to select one of application 112A, application 112B, and application 112C from a list (i.e., a list of potential target applications), proceed to execute the selected application on client device 110, navigate to and/or configure a desired start page for the selected application, and instruct start page routing logic 116 to associate the desired start page with the selected application as the user-defined start page. In response, components of start page-routing logic 116 regard the selected application as a target application, as described with respect to the embodiment depicted in FIG. 3. More specifically, start-page routing logic user interface module 304 can, in some embodiments, provide a GUI layer (e.g., an overlay on client user interface 114) that includes a widget (e.g., a button) for setting the desired start page as the user-defined start page and permits a user to interact with a selected program via client user interface 114 as normal. In response to a user of client device 110 setting a user-defined start page for an application, start-page routing logic user interface module 304 saves code, data, code and data, or any other information for associating the user-defined start page with the selected application to start-page database 118. The information for associating the user-defined start page with the application can be stored, for example, as a configuration file (e.g., an XML file) or using a mobile local database (e.g., SQLite). In various embodiments, the user-defined start page can include configurations of one or more GUI widgets (e.g., an arrangement of one or more windows, toolbars, and buttons), graphical representation(s) of one or more identified data files, graphical representation(s) of one or more executable objects, or any combination of the aforementioned elements.

In the embodiment depicted in FIG. 3, start-page routing logic 116 includes monitoring module 306. In general, monitoring module 306 monitors at least one of (i) one or more target applications (i.e., application(s) that are associated with user-defined start pages) that can execute, at least in part, on client device 110 and (ii) client user interface 114 for trigger conditions that are respectively associated with the target applications. In some embodiments, one or more trigger conditions are predefined for all target applications (e.g., detecting any interaction of client user interface 114 that starts or wakes a target application). In other embodiments, a user of client device 110 can associate specific trigger condition(s) with respective target applications via start-page routing logic user interface module 304. For example, a user of client device 110 may associate a user-defined interaction on a touchscreen of client device 110 with a target application (e.g., a three-fingered pinch or swipe) such that start-page routing logic 116 causes client user interface 114 to present (i) a user-defined start page for the target application in response to detecting the user-defined interaction or (ii) a default start-page in response to detecting another interaction that starts or wakes the target application.

Persons of ordinary skill in the art will understand that monitoring module 306 can monitor various status indicators, flags, performance metrics, or other properties of target application(s), client user interface 114, client device 110, or any combination of such elements to determine if one or more trigger conditions have been satisfied. Additionally, persons of ordinary skill in the art will understand that the choice of properties or elements to monitor is, in general, based on whether or not monitoring module 206 is implemented as an application or a module of an application that is executed by an operating system of client device 110; as one or more daemon processes of an operating system of client device 110; as one or more plug-ins that modify target applications (e.g., applications 112); or as any combination of the aforementioned types of code. In response to determining that one or more trigger conditions have been met for a respective target application, monitoring module 306 causes client device 110 to execute application interface module 308.

In the embodiment depicted in FIG. 3, start-page routing logic 116 includes application interface module 308. In some embodiments, monitoring module 306 identifies, to application interface module 308, a target application for which trigger condition(s) have been met, and in response, application interface module 308 queries start-page database 118 for information enabling application interface module 308 to cause client user interface 114 to present the user-defined start page that is associated with the target application. In other embodiments, monitoring module 306 queries start-page database 118 for such information and provides the identity of the target application and the information to application interface module 308. In general, application interface module 308 operates to interface with target applications such that a user-defined start page is presented on client user interface 114 of client device 110 when monitoring module 306 determines that trigger condition(s) have been met (e.g., when a user of client device 110 starts or wakes a respective target application). In various embodiments, application interface module 308 interfaces with application programming interfaces (APIs) of target applications, an API of an operating system of client device 110, or APIs of both target applications and the operating system of client device 110 based on how start-page routing logic 116, and application interface module 308 in particular, is implemented on client device 110. In some embodiments, for example, application interface module 308 instructs a target application to execute one or more operations (e.g., operations associated with clicking on various widget(s) or loading various file(s)) to present a respective user-defined start page on client user interface 114 of client device 110 without additional input from the user of client device 110.

FIG. 4 is a flowchart depicting operations for presenting a user-defined start page on a computing device within the computing environment of FIG. 1, in accordance with an embodiment of the present invention. For example, FIG. 4 is a flowchart depicting operations 400 of start-page routing logic 116 on client device 110 within computing environment 100. In embodiments including start-page routing logic user interface module 304, monitoring module 306, and application interface module 308, operations 400 are variously performed by the aforementioned modules of start-page routing logic 116, as will be understood by persons of ordinary skill in the art.

In operation 402, start-page routing logic 116 (e.g., start-page routing logic user interface module 304) presents, on client user interface 114, a start-page routing logic user interface. As described with respect to FIGS. 2A and 2B, for example, start-page routing logic 116 can present the start page routing logic user interface in response to a user of client device 110 selecting and activating the icon for start-page routing logic settings 216 on client device user interface 114. As discussed with respect to start-page routing logic user interface module 304 of FIG. 3, for example, in some embodiments GUI layer is provided (e.g., an overlay on client user interface 114) that includes a widget (e.g., a button) for setting the desired start page as the user-defined start page and that permits a user to interact with a selected program via client user interface 114 as normal. Based on detected user interaction(s) with the start-page routing logic user interface, start-page routing logic 116 associates a user-defined start-page with a respective application (e.g., one of applications 112) in operation 404. As described herein, start-page routing logic 116 can store code, data, code and data, or any other information for associating the user-defined start-page with the respective application (i.e., the respective target application) to start-page database 118 in operations 404. As previously discussed, the information for associating the user-defined start page with the application can include configurations of one or more GUI widgets (e.g., an arrangement of one or more windows, toolbars, and buttons), graphical representation(s) of one or more identified data files, graphical representation(s) of one or more executable objects, or any combination of the aforementioned elements.

In operation 406, start-page routing logic 116 (e.g., monitoring module 306) monitors at least one of client user interface 114, an operating system executing on client device 110, and one or more target applications (e.g., applications 112) for trigger conditions that are associated with the one or more target applications. For example, start-page routing logic 116 can monitor client user interface 114 for a user interaction, such as a click, on one of application icon 212A, application icon 212B, or application icon 212C that causes client device 110 to execute code corresponding to application 112A, application 112B, or application 112C respectively. Persons of ordinary skill in the art will understand that start-page routing logic 116 can monitor various status indicators, flags, performance metrics, or other properties of target application(s), client user interface 114, client device 110, or any combination of such elements to determine if one or more trigger conditions have been satisfied. If start-page routing logic 116 detects interactions on client user interface 114, operations of an operating system executing on client device 110, or operations of target applications that do not meet the trigger condition(s) of any target application(s) (decision 408, NO branch), start-page routing logic 116 continues to monitor client user interface 114, the operating system executing on client device 110, and/or the target applications for trigger conditions (operation 406) until trigger condition(s) are met or start-page routing logic 116 is terminated.

If trigger condition(s) of a target application are met (decision 408, YES branch), start-page routing logic 116 queries start-page database 118 for at least the user-defined start page that is associated with target application for which the trigger condition(s) are met (operation 410). In the embodiments depicted in FIGS. 2A and 2B, for example, start-page routing logic 116 queries start-page database 118 for the user-defined start-page that is associated with application 112A in response to a user of client device 110 selecting and activating application icon 212A on client user interface 114. As described with respect to FIG. 3, monitoring module 306 or application interface module 308 can query start-page database 118 for the aforementioned information in various embodiments of the present invention. In operation 412, start-page routing logic 116 (e.g., application interface module 308) interfaces with the target application, the operating system executing on client device 110, or both the target application and the operating system executing on client device 110 to cause client user interface 114 to present the respective user-defined start page on a screen of client device 110. In some embodiments, for example, start-page routing logic 116 instructs a target application to execute one or more operations (e.g., operations associated with clicking on various widget(s) or loading various file(s)) to present a respective user-defined start page on client user interface 114 of client device 110 without additional input from the user of client device 110. Start-page routing logic 116 (e.g., monitoring module 306) continues to monitor client user interface 114, the operating system executing on client device 110, and/or other target applications for trigger conditions (operation 406) until trigger condition(s) are met or start-page routing logic 116 is terminated.

FIG. 5 is a block diagram of components of a computing device, generally designated 500, in accordance with an embodiment of the present invention. In one embodiment, computing system 500 is representative of client device 110 within computing environment 100, in which case client device 110 includes applications 112, client user interface 114, start-page routing logic 116, and start-page database 118.

It should be appreciated that FIG. 4 provides only an illustration of one implementation and does not imply any limitations with regard to the environments in which different embodiments may be implemented. Many modifications to the depicted environment may be made.

Computing system 500 includes processor(s) 502, cache 506, memory 504, persistent storage 510, input/output (I/O) interface(s) 512, communications unit 514, and communications fabric 508. Communications fabric 508 provides communications between cache 506, memory 504, persistent storage 510, communications unit 514, and input/output (I/O) interface(s) 512. Communications fabric 508 can be implemented with any architecture designed for passing data and/or control information between processors (such as microprocessors, communications and network processors, etc.), system memory, peripheral devices, and any other hardware components within a system. For example, communications fabric 508 can be implemented with one or more buses or a crossbar switch.

Memory 504 and persistent storage 510 are computer readable storage media. In this embodiment, memory 504 includes random access memory (RAM). In general, memory 504 can include any suitable volatile or non-volatile computer readable storage media. Cache 506 is a fast memory that enhances the performance of processor(s) 502 by holding recently accessed data, and data near recently accessed data, from memory 504.

Program instructions and data used to practice embodiments of the present invention may be stored in persistent storage 510 and in memory 504 for execution by one or more of the respective processor(s) 502 via cache 506. In an embodiment, persistent storage 510 includes a magnetic hard disk drive. Alternatively, or in addition to a magnetic hard disk drive, persistent storage 510 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 510 may also be removable. For example, a removable hard drive may be used for persistent storage 510. Other examples include optical and magnetic disks, thumb drives, and smart cards that are inserted into a drive for transfer onto another computer readable storage medium that is also part of persistent storage 510.

Communications unit 514, in these examples, provides for communications with other data processing systems or devices. In these examples, communications unit 514 includes one or more network interface cards. Communications unit 514 may provide communications through the use of either or both physical and wireless communications links. Program instructions and data used to practice embodiments of the present invention may be downloaded to persistent storage 510 through communications unit 514.

I/O interface(s) 512 allows for input and output of data with other devices that may be connected to computer system 500. For example, I/O interface(s) 512 may provide a connection to external device(s) 516 such as a keyboard, keypad, a touch screen, and/or some other suitable input device. External device(s) 516 can also include portable computer readable storage media such as, for example, thumb drives, portable optical or magnetic disks, and memory cards. Software and data used to practice embodiments of the present invention can be stored on such portable computer readable storage media and can be loaded onto persistent storage 510 via I/O interface(s) 512. I/O interface(s) 512 also connect to display 518.

Display 518 provides a mechanism to display or present data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As used herein, a list of alternatives such as “at least one of A, B, and C” should be interpreted to mean “at least one A, at least one B, at least one C, or any combination of A, B, and C.”

Additionally, the phrase “based on” should be interpreted to mean “based, at least in part, on.”

The term “exemplary” means of or relating to an example and should not be construed to indicate that any particular embodiment is preferred relative to any other embodiment.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for presenting start-pages on a graphical user interface, comprising:
monitoring, by one or more computer processors, at least one of a first user interface of a computing device, an operating system executing on the computing device, and an application executing on the computing device to detect one or more trigger conditions that are associated with the application on the first user interface;
detecting, by one or more computer processors, the one or more trigger conditions on the first user interface, and in response, querying, by one or more computer processors, a start-page database for information that describes, at least in part, a user-defined start page that is associated with the application; and
interfacing, by one or more computer processors, with at least one of the application and the operating system such that the first user interface presents the user-defined start page and not a default start page on a screen of the computing device.

2. The method of claim 1, further comprising:
presenting, by one or more computer processors, a second user interface on the screen of the computing device;
detecting, by one or more computer processors, an interaction with the second user interface that associates the user-defined start page with the application; and
storing, by one or more computer processors, the information that describes, at least in part, the user-defined start page to the start-page database.

3. The method of claim 2, wherein the second user interface is an overlay on the first user interface.

4. The method of claim 2, further comprising:
associating, by one or more computer processors, a user-defined interaction with the application as the one or more trigger conditions.

5. The method of claim 2, wherein:
the one or more trigger conditions that are associated with the application is a click on an icon that is (i) presented on the first user interface and (ii) associated with the application; and
the first user interface presents, in response to the click on the icon, one of the user-defined start page and the default start page based on a query for the information that describes, at least in part, the user-defined start page in the start-page database.

6. The method of claim 2, wherein the second user interface is presented in response to detecting on the first user interface, by one or more computer processors, an interaction with an icon that is associated with the second user interface.

7. A computer program product for presenting start-pages on a graphical user interface, the computer program product comprising:
a computer readable storage medium and program instructions stored on the computer readable storage medium, the program instructions comprising:
program instructions to monitor at least one of a first user interface of a computing device, an operating system executing on the computing device, and an application executing on the computing device to detect one or more trigger conditions that are associated with the application on the first user interface;
program instructions to detect the one or more trigger conditions on the first user interface, and in response, querying, by one or more computer processors, a start-page database for information that describes, at least in part, a user-defined start page that is associated with the application; and
program instructions to interface with at least one of the application and the operating system such that the first user interface presents the user-defined start page and not a default start page on a screen of the computing device.

8. The computer program product of claim 7, the program instructions further comprising:
program instructions to present a second user interface on the screen of the computing device;
program instructions to detect an interaction with the second user interface that associates the user-defined start page with the application; and
program instructions to store the information that describes, at least in part, the user-defined start page to the start-page database.

9. The computer program product of claim 8, wherein the second user interface is an overlay on the first user interface.

10. The computer program product of claim 8, the program instructions further comprising:
associating, by one or more computer processors, a user-defined interaction with the application as the one or more trigger conditions.

11. The computer program product of claim 8, wherein:
the one or more trigger conditions that are associated with the application is a click on an icon that is (i) presented on the first user interface and (ii) associated with the application; and
the first user interface presents, in response to the click on the icon, one of the user-defined start page and the default start page based on a query for the information that describes, at least in part, the user-defined start page in the start-page database.

12. The computer program product of claim 8, wherein the second user interface is presented in response to detecting on the first user interface, by one or more computer processors, an interaction with an icon that is associated with the second user interface.

13. A computer system for presenting start-pages on a graphical user interface, the computer system comprising:
one or more computer processors;
one or more computer readable storage media;
program instructions stored on the one or more computer readable storage media for execution by at least one of the one or more processors, the program instructions comprising:
program instructions to monitor at least one of a first user interface of a computing device, an operating system executing on the computing device, and an application executing on the computing device to detect one or more trigger conditions that are associated with the application on the first user interface;
program instructions to detect the one or more trigger conditions on the first user interface, and in response, querying, by one or more computer processors, a start-page database for information that describes, at least in part, a user-defined start page that is associated with the application; and
program instructions to interface with at least one of the application and the operating system such that the first user interface presents the user-defined start page and not a default start page on a screen of the computing device.

14. The computer system of claim 13, the program instructions further comprising:
program instructions to present a second user interface on the screen of the computing device;
program instructions to detect an interaction with the second user interface that associates the user-defined start page with the application; and
program instructions to store the information that describes, at least in part, the user-defined start page to the start-page database.

15. The computer system of claim 14, wherein the second user interface is an overlay on the first user interface.

16. The computer system of claim 14, the program instructions further comprising:
associating, by one or more computer processors, a user-defined interaction with the application as the one or more trigger conditions.

17. The computer system of claim 14, wherein:
the one or more trigger conditions that are associated with the application is a click on an icon that is (i) presented on the first user interface and (ii) associated with the application; and
the first user interface presents, in response to the click on the icon, one of the user-defined start page and the default start page based on a query for the information that describes, at least in part, the user-defined start page in the start-page database.

18. The computer system of claim 14, wherein the second user interface is presented in response to detecting on the first user interface, by one or more computer processors, an interaction with an icon that is associated with the second user interface.
